(19) United States
(12) Patent Application Publication
(10) Pub. No.: US 2026/0312304 A1
(43) Pub. Date: Oct. 8, 2026

(54) CLAMP FOR SECURING ARTICLES

(71) Applicant: Sigma Engineered Solutions, Garner, NC (US)

(72) Inventors: Vinayak Manohar CHAVAN, Pune (IN); Umakant Raghunath PATIL, Pune (IN)

(21) Appl. No.: 19/170,187

(22) Filed: Apr. 4, 2025

(51) Int. Cl. H01R 4/36

(52) U.S. Cl. CPC H01R 4/36

(57) ABSTRACT

The present invention provides a clamp (100) for securing articles. The clamp (100) comprises a first clamping member (110), a second clamping member (120), a lug (130) and a securing element (140). The first clamping member (110) is having a first engagement surface (112). The second clamping member (120) is having a second engagement surface (122), wherein the second clamping member (120) is adapted to connect with the first clamping member (110) defining a first accommodating space (150) configured to secure a first article (115). The lug (130) extends from the second clamping member (120), the lug (130) and the second clamping member (120) define a second accommodating space (160) configured to secure a second article (125). The securing element (140) is mounted on the lug (130) for retaining the second article (125) within the second accommodating space (160).

### TECHNICAL FIELD

The present invention. relates to clamps used in electrical systems. More specifically, the present invention relates to a ground clamp capable of securing articles in multiple orientations.

### BACKGROUND

Electrical grounding systems require strong and dependable connections between grounding conductors, electrical conduits, and related components to work safely and effectively. Many traditional ground clamps cannot hold multiple conduits or need complicated setups to secure conduits in various directions. These issues can lead to longer installation times, limited flexibility, and reduced performance in certain situations.

Most existing clamps are designed with only one accommodating space or a fixed layout, making them unsuitable for securing conduits positioned at different angles. Furthermore, many clamps cannot securely hold conduits of different shapes or sizes and may lack the strength needed to perform reliably in outdoor or demanding environments.

Therefore, there is a need for a ground clamp that overcomes these challenges by providing a reliable way to secure electrical conduits in multiple orientations.

### STATEMENT OF THE INVENTION

According to the present aspect of the invention, there is provided a clamp for securing articles. The clamp includes a first clamping member, a second clamping member, a lug and a securing element. The first clamping member is having a first engagement surface. The second clamping member is having a second engagement surface, wherein the second clamping member is adapted to connect with the first clamping member defining a first accommodating space therebetween configured to secure a first article. The lug extends from the second clamping member, the lug and the second clamping member defining a second accommodating space therebetween configured to secure a second article. The securing element is mounted on the lug for retaining the second article within the second accommodating space.

In an aspect, the first clamping member and the second clamping member are connected together by at least two fasteners wherein the fasteners apply compressive force to secure the first article within the first accommodating space. In an aspect, the fasteners are bolts with flanged heads, and the first clamping member and the second clamping member includes countersunk holes for receiving the fasteners. The first accommodating space is shaped to conform to the outer surface of the first article, allowing the first accommodating space to accommodate articles with circular or non-circular cross-sections.

In an aspect, the second accommodating space includes a first channel for securing a second article in a direction lateral to the longitudinal axis of the second clamping member and a second channel for securing the second article in a direction transverse to the longitudinal axis of the second clamping member. In an aspect, first channel and the second channel are arranged substantially in crosswise orientations relative to each other. The first channel is configured to receive the second article in a lateral orientation and the second channel is configured to receive the second article in a transverse orientation relative to a longitudinal axis of the second clamping member. The first channel and the second channel are arranged to enable selective reception of the second article in either the lateral or transverse direction relative to the longitudinal axis of the second clamping member. In an aspect, the second accommodating space is configured to allow, insertion of the second article in a direction transverse to or lateral to a longitudinal axis of the second clamping member without requiring adjustment or reconfiguration of the clamp structure.

The first channel and the second channel are formed by the lug and a recessed groove on the second clamping member, the first channel and the second channel collectively defining the second accommodating space.

In an aspect, the lug is integrally formed with the second clamping member and includes a curved inner surface that defines the first channel, and the second clamping member includes a recessed groove that defines the second channel. The lug extends perpendicularly from the second clamping member and includes a curved inner surface that defines the first channel, and the second clamping member includes a recessed groove that defines a second channel, wherein the channels collectively define the second accommodating space. The lug is formed with an arcuate profile along the second accommodating space to partially encircle the second article. The lug includes a serrated surface on the inner face to improve the frictional engagement between the second article and the first channel.

In an aspect, the first channel and the second channel partially overlaps to form the second accommodating space having a substantially open profile for receiving the second article. In such embodiment, the second accommodating space enables side insertion of the second article in either a transverse or lateral direction relative to a longitudinal axis of the second clamping member, without requiring adjustment or reconfiguration of the clamp structure. In an aspect, the first channel and the second channel intersect to form a combined opening profile of approximately 270 degrees, allowing insertion of the second article from multiple directions.

In an aspect, the lug is integrally formed with the second clamping member, wherein the lug includes a threaded opening section for mounting the securing element. The securing element is a screw which includes a flattened head for uniform clamping of the second article. The securing element is configured to retain the second article in the second accommodating space when positioned in either the first channel or the second channel. The securing element mounted on the lug applies clamping pressure simultaneously across the first channel and the second channel to secure the article within the second accommodating space. The lug includes a threaded opening section for mounting the securing element, and wherein the securing element includes a flattened head for uniform clamping of the second article.

In an aspect, the clamp is a grounding clamp, the first article is a grounding electrode, and the second article is a grounding conductor.

### BRIEF DESCRIPTION OF THE DRAWINGS

Other features and advantages of the invention will become apparent when reading the detailed description given below, purely by way of example and in a non-limitative manner, referring to the following figures:

FIG. 1 illustrates a perspective view of a clamp in accordance with the present invention, showing the first and second clamping members connected together and the securing element mounted on the lug;

FIG. 2 is a front view of the clamp, illustrating the engagement of the first and second clamping members and the lug forming the second accommodating space;

FIG. 3 provides a rear view of the clamp, showing the lug extending from the second clamping member and its integration into the second accommodating space;

FIG. 4 is a side view of the clamp, showing the securing element mounted on the lug and the positioning of the first and second clamping members connected by fasteners.

FIG. 5 illustrates the clamp with a second article positioned in the second accommodating space in a transverse orientation relative to the longitudinal axis of the second clamping member; and

FIG. 6 shows the clamp with a second article positioned in the second accommodating space in a lateral orientation relative to the longitudinal axis of the second clamping member;

### DETAILED DESCRIPTION

An embodiment of this invention, illustrating its features, will now be described in detail. The words "comprising, "having, "containing," and "including," and other forms thereof, are intended to be equivalent in meaning and be open ended in that an item or items following any one of these words is not meant to be an exhaustive listing of such item or items, or meant to be limited to only the listed item or items.

The present invention relates to a clamp configured for securing articles, such as those used in electrical grounding systems. The clamp accommodates and secures at least one or more articles in different orientations, including transverse and lateral directions relative to the structure of the clamp providing a reliable and connection mechanism.

The terms “first,” “second,” and the like, herein do not denote any order, quantity, or importance, but rather are used to distinguish one element from another, and the terms “an” and “a” herein do not denote a limitation of quantity, but rather denote the presence of at least one of the referenced item. The disclosed embodiments are merely exemplary of the invention, which may be embodied in various forms.

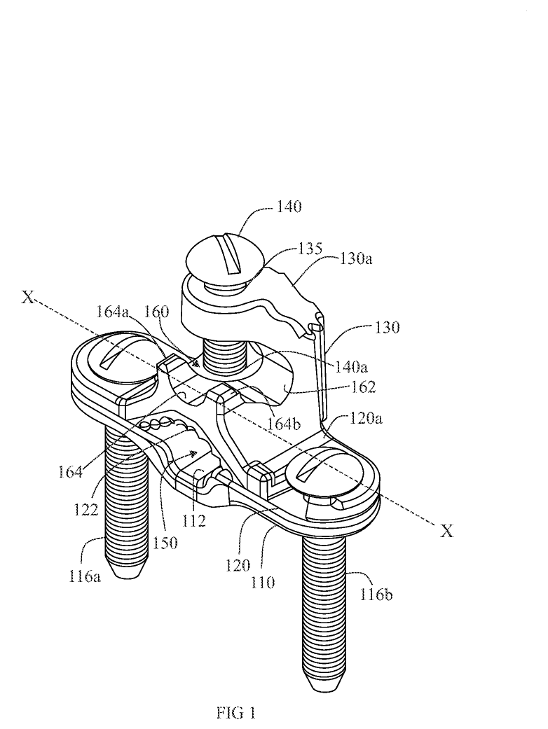

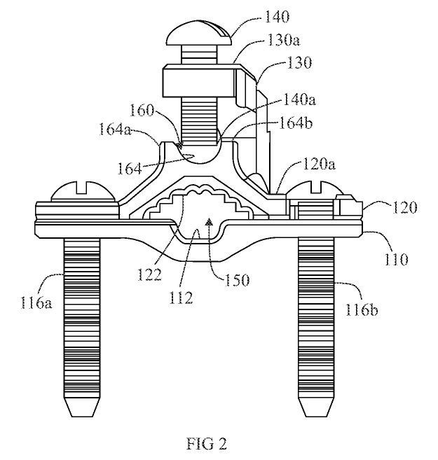

Referring now to FIG. 1 and FIG. 2, a clamp (100) for securing articles in accordance with the present invention is provided. The clamp (100) is particularly suited for use in electrical installations. It can be used in residential, commercial, or industrial applications, providing flexibility to meet a wide range of grounding requirements. As used herein, the term "article" refers to any suitable structure, component, or element that may be secured by the clamp, including but not limited to electrical conduits (e.g., EMT, rigid, flexible, or PVC conduits), grounding electrodes (e.g., ground rods, metal pipes, rebar), grounding conductors (e.g., solid or stranded wires, bus bars), and any other electrically or mechanically connectable elements. In the present embodiment, the clamp (100) is a grounding clamp to establish a secure electrical connection between a grounding conductor and a grounding electrode to ensure effective grounding in an electrical system.

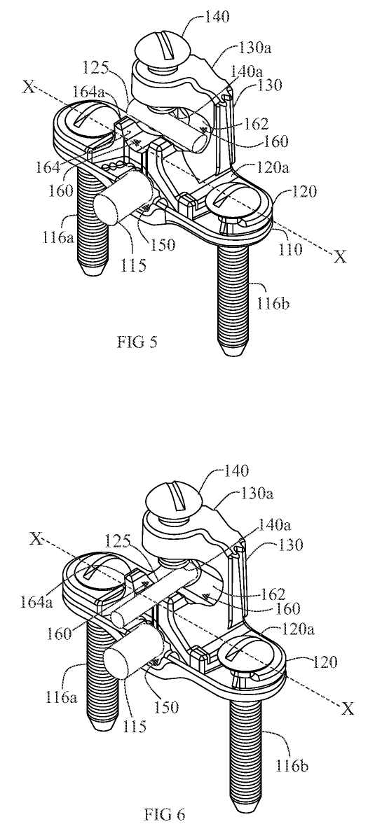

The clamp (100) includes a first clamping member (110), a second clamping member (120), a lug (130) and a securing element (140). The first clamping member (110) is an elongated structure having a first engagement surface (112). The first engagement surface (112) is a U-shaped groove arrangement adapted to securely hold or retain atleast one first article (115) as shown in FIG. 5 and FIG. 6. In the present embodiment, the first article (115) is a grounding electrode (e.g., ground rod, metal pipe, rebar). The first engagement surface (112) may be serrated or may have a textured surface or knurled surface. The first engagement surface (112) is positioned substantially at a central portion of the first clamping member (110). It may be obvious to a person skilled in the art to position the first engagement surface (112) anywhere between the two ends of the first clamping member (110).

The second clamping member (120) is an elongated structure having a second engagement surface (122) configured to complement the first engagement surface (112) of the first clamping member (110). The second engagement surface (122) is a U-shaped serrated groove arrangement. The second engagement surface (122) may also have a textured surface or knurled surface to increase the friction between the first article (115) and the clamping members (110, 120) within the respective engagement surfaces.

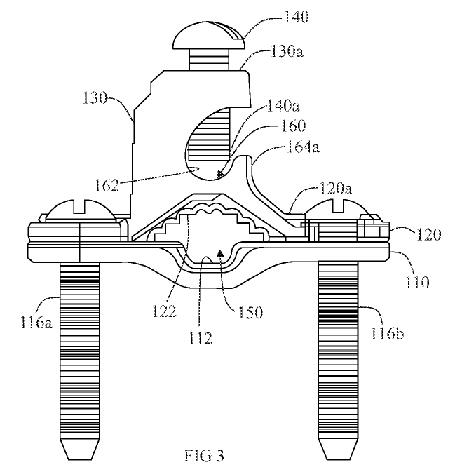

The second clamping member (120) is adapted to connect with the first clamping member (110) using fasteners (116a, 116b) in the assembled condition as shown in FIG. 2 and FIG. 3. The second clamping member (120) is positioned above the first clamping member (110) in such a way that the first engagement surface (112) of the first clamping member (110) complements with the second engagement surface (122) of the second clamping member (120). The connection between the first clamping member (110) and the second clamping member (120) defines a first accommodating space (150) therebetween configured to secure the first article (115). The first accommodating space (150) is defined as the region formed between the first engagement surface (112) of the first clamping member (110) and the second engagement surface (122) of the second clamping member (120). The first accommodating space (150) is configured to securely retain the first article (115) when the first clamping member (110) and the second clamping member (120) are fastened together. Specifically, the first accommodating space (150) is configured to secure the first article (125) in a direction transverse to the longitudinal axis (X) of the first clamping member (110).

In the present embodiment, the first clamping member (110) and the second clamping member (120) are connected together by at least two fasteners (116a, 116b) wherein the fasteners (116a, 116b) apply compressive force to secure the first article (115) within the first accommodating space (150). The fasteners (116a, 116b) are positioned at opposite ends of the first clamping member (110) and the second clamping member (120) to ensure even distribution of clamping force across the first accommodating space (150). By way of non-limiting example, the fasteners (116a, 116b) are bolts with flanged heads. The first clamping member (110) and the second clamping member (120) include countersunk holes for receiving the fasteners (116a, 116b), allowing the bolt heads to abut with the surface of the clamping members (110, 120). It may be obvious to a person skilled in the art to use any similar fastening mechanism such as bolt and nuts, rivets, snap fit arrangements, and the like to connect both the first clamping member (110) and the second clamping member (120) to configure the first accommodating space (150).

Further, the first accommodating space (150) is shaped to conform to the outer surface of the first article (115), allowing the first accommodating space (150) to accommodate the first article (115) with circular or non-circular cross-sections. To accommodate the first article (115) with circular cross-sections, the first accommodating space (150) has a generally arcuate or semi-cylindrical profile, enabling it to securely encase the rounded surface of the first article (115). For non-circular conduits, such as those with oval, square, or irregular cross-sections, the first accommodating space (150) may include flexible or adaptive features, such as adjustable engagement surfaces, textured patterns, or grooves to securely hold the first article (115).

Referring again to FIG. 2 and FIG. 3, the lug (130) is arranged on a top surface (120a) of the second clamping member (120). In the present embodiment, the lug (130) is integrally extending from the second clamping member (120). It may be obvious to a person skilled in the art to configure the lug (130) as a separate extension (not integral) from the second clamping member (120). In such embodiment, the lug (130) may be fastened to the second clamping member (120) using any fasteners or similar arrangements.

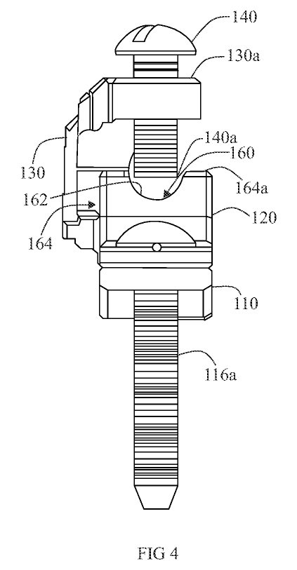

In the present embodiment, the lug (130) has an arcuate profile that extends outwardly perpendicular from the second clamping member (120) and is arranged substantially perpendicular to the second clamping member (120) as shown in FIG. 4. The lug (130) has a top portion (130a) which extends or projects parallel to the second clamping member (120). The lug (130) and the second clamping member (120) define a second accommodating space (160) therebetween configured to secure a second article (125) as shown in FIGS. 5 and 6. Specifically, the second accommodating space (160) is defined between the top portion of the lug (130) and the top surface (120a) of the second clamping member (120). The second accommodating space (160) is provided to retain the second article (125) securely in either a transverse orientation or a lateral orientation relative to the longitudinal axis (X) of the second clamping member (120). The second accommodating space (160) has a substantially open configuration enabling side insertion of the second article (125), wherein the second accommodating space (160) allows insertion of the second article (125) in a direction transverse to or lateral to a longitudinal axis of the second clamping member (120). In the present embodiment, the second article (125) is a grounding conductor (e.g., solid or stranded wire, bus bar).

Specifically, the second accommodating space (160) includes a first channel (162) for securing a second article (125). The first channel (162) and the second channel (164) are arranged substantially in crosswise orientations relative to each other, such that each channel (162, 164) lies along a different directional axis within a shared plane. In the present embodiment, the crosswise arrangement refers to the first channel (162) extending substantially parallel to the longitudinal axis (X) of the second clamping member (120), and the second channel (164) extending substantially perpendicular to the longitudinal axis (X) of the second clamping member (120). The first channel (162) is configured to receive the second article (125) in a lateral orientation or in a direction lateral to the longitudinal axis (X) of the second clamping member (120) and a second channel (164) for securing the second article (125) in a transverse orientation or in a direction transverse to the longitudinal axis (X) of the second clamping member (120).In the present embodiment, the first channel (162) and the second channel (164) are arranged to enable selective reception of the second article (125) in either a lateral or transverse direction relative to a longitudinal axis of the second clamping member (120). Specifically, the second accommodating space (160) is configured to allow, insertion of the second article (125) in a direction transverse to or lateral to a longitudinal axis of the second clamping member (120) without requiring adjustment or reconfiguration of the clamp structure.

The term "selective reception" refers to the ability of the clamp (100) to accommodate the second article (125) in either of the two predefined orientation, lateral or transvers based on the application requirement, without the need to reconfigure, rotate, or reposition the lug (130) or any part of the clamp structure. The first channel (162) and the second channel (164) are formed with fixed geometries that independently support the second article (125) in their respective orientations. The clamp (100) does not require any manual adjustment, rotational movement, or reassembly to alternate between lateral and transverse orientations. Instead, the user can insert the second article (125) directly into the corresponding channel based on the desired orientation, and the securing element (140) mounted on the lug (130) is configured to retain the second article in either case.

Further, the clamp structure refers to the fixed spatial arrangement of the lug (130), the second clamping member (120), and the respective first and second channels (162, 164), which together define the geometry of the second accommodating space (160). In the present invention, these components are preconfigured to permit selective insertion of the second article (125) in either orientation without necessitating rotation of the lug, repositioning of the clamping members, or the use of interchangeable parts or movable brackets.

In the present embodiment, the first channel (162) is configured on the lug (130). Specifically, the lug (130) includes a curved inner surface that defines the first channel (162) that partially encircle the second article (125) when disposed thereon. Specifically, the curved inner surface of the lug (130) is contoured to partially encircle the outer surface of the second article (125) when it is positioned in the first channel (162). The lug (130) includes a serrated surface on its inner face. This configuration improves the frictional engagement between the second article (125) and the lug (130). The first channel (162) is configured in such a way that the first channel (162) can hold the second article (125) in a lateral orientation relative to the longitudinal axis (X) of the second clamping member (120), specifically lateral/parallel to the longitudinal axis (X) of the second clamping member (120) as shown in FIG. 5. In such configuration, the second article (125) will be arranged perpendicular to the first article (115).

Further, the second clamping member (120) includes a recessed groove that defines the second channel (164). The second channel (164) is formed by the recessed groove on the second clamping member (120). Specifically, the second channel (164) is positioned on the top surface (120a) of the second clamping member (120). In the present embodiment, the second channel (164) is positioned opposite to the second engagement surface (122) of the second clamping member (120). The second channel (164) has a U- shaped recessed groove portion to hold the second article (125) thereon. The second channel (164) may also have a serrated or textured or knurled surface to increase the frictional engagement between the second channel (164) and the second article (125). Either side of the second channel (164) has a projected profile (164a, 164b) to prevent any displacement of the second article (125) and to hold the second article (125) within the space of the second channel (164). The second channel (164) is configured in such a way that the second channel (164) can hold the second article (125) in a transverse orientation relative to the longitudinal axis of the second clamping member (120), specifically across the longitudinal axis (X) of the second clamping member (120) as shown in FIG. 6. In such configuration, the second article (125) will be arranged parallel to the first article (115).

The first channel (162) and the second channel (164) collectively define the second accommodating space (160). In the present embodiment, the first channel (162) and the second channel (164) are arranged perpendicular to each other, providing a dual-channel arrangement within the second accommodating space (160). The perpendicular arrangement allows the second article (125) to be positioned in either a lateral orientation (parallel to the longitudinal axis (X) of the second clamping member (120), within the first channel (162) or a transverse orientation (across the longitudinal axis (X) of the second clamping member (120), within the second channel (164).

In the present embodiment, the first channel (162) and the second channel (164) partially overlaps to form the second accommodating space (160) having a substantially open profile for receiving the second article (125). This arrangement allows the second article (125) to be inserted from the side either in a lateral or transverse direction. The substantially open profile which is typically greater than 180 degrees but less than 360 degree eliminates the need to feed the second article (125) through a closed loop or to adjust the clamp geometry during installation. Instead, the user can directly position the second article (125) into the corresponding channels based on the required orientation (lateral or transverse), with the open geometry facilitating side insertion. In an embodiment, the first channel (162) and the second channel (164) intersect to form a combined opening profile of approximately 270 degrees in the second accommodating space (160), allowing insertion of the second article (125) from multiple directions. The 270-degree opening profile ensures that the second article (125) can be inserted laterally, transversely, or at an intermediate angle without requiring threading through a closed loop. The substantially open configuration of the second accommodating space (160) simplifies the positioning of the second article (125).

Further referring to FIG. 1, the lug (130) includes a threaded opening section (135) for mounting the securing element (140). Specifically, the top portion (130a) that projects parallel to the second clamping member (120) includes the threaded opening section (135) to insert the securing element (140) therethrough. The securing element (140) is mounted on the lug (130) for retaining the second article (125) within the second accommodating space (160). The securing element (140) is adapted to move downwards towards and engages with the second article (125) placed within the second accommodating space (160). Specifically, a tail end (140a) of the securing element (140) engages with the second article (125) positioned within the second accommodating space (160). The securing element (140) is configured to retain the second article (125) in the second accommodating space (160) when positioned in either the first channel (162) or the second channel (164). The securing element (140) mounted on the lug (130) applies clamping pressure simultaneously across the first channel (162) and the second channel (164) to secure the second article (125) within the second accommodating space (160). In the present embodiment, a single securing element (140) a single securing element (140) is sufficient to apply clamping pressure to the second article (125) regardless of whether it is positioned in the first channel (162) or the second channel (164), due to the partially overlapping arrangement of the first channel (162) and the second channel (164) within the second accommodating space (160).

In the present embodiment, the securing element (140) is a screw which includes a flattened head for uniform clamping of the second article (125) when the second article (125) is positioned within the second accommodating space (160). The lug (130) includes the threaded opening section (135) for mounting the screw, and the screw includes a flattened head for uniform clamping of the second article (125). The tail end (140a) of the screw is adapted to engage with the second article (125) positioned within the first channel (162) or the second channel (164) or the both. It may be obvious to a person skilled in the art to use any other securing element means to secure the second article (125) within the second accommodating space (160).

During operation, the first article (115) is positioned within the first accommodating space (150), and the first clamping member (110) and the second clamping member (120) is fastened together to secure the first article (115) positioned within the first accommodating space (150). The second article (125) is inserted into the second accommodating space (160) through either the first channel (162) or the second channel (164) for lateral orientation of the second article (125) and the transverse orientation of the second article (125) respectively, depending on the required orientation. The securing element (140) is then tightened to apply clamping pressure, ensuring that the second article (125) remains securely within the second accommodating space (160).

The advantage of the present invention is to provide a clamp (100) for securing articles in grounding systems. The clamp (100) includes a dual-channel configuration in the second accommodating space (160), enabling secure retention of articles such as conduits, grounding wires, grounding electrodes, grounding conductors etc in both transverse and lateral orientations relative to the second clamping member (120). This simplifies installation by allowing side insertion of the articles through the 270-degree open profile, eliminating the need for threading through closed loops. The engagement surfaces, including curved and recessed profiles, ensure uniform clamping pressure and prevent conduit slippage under mechanical stress or environmental conditions.

The foregoing descriptions of specific embodiments of the present invention have been presented for purposes of illustration and description. They are not intended to be exhaustive or to limit the present invention to the precise forms disclosed, and obviously, many modifications and variations are possible in light of the above teaching. The embodiments were chosen and described in order to explain the principles of the present invention best and its practical application, to thereby enable others skilled in the art to best utilise the present invention and various embodiments with various modifications as are suited to the particular use contemplated. It is understood that various omission and substitutions of equivalents are contemplated as circumstance may suggest or render expedient, but such are intended to cover the application or implementation without departing from the scope of the claims of the present invention.

We claim:

1. A clamp for securing articles, the clamp comprising:
a first clamping member having a first engagement surface;
a second clamping member having a second engagement surface, wherein the second clamping member is adapted to connect with the first clamping member defining a first accommodating space therebetween configured to secure a first article;
a lug extending integrally from the second clamping member, the lug and the second clamping member defining a second accommodating space therebetween configured to secure a second article, wherein the second accommodating space comprises a first channel and a second channel that are arranged substantially in crosswise orientations relative to each other, the first channel is configured to receive the second article in a lateral orientation and the second channel is configured to receive the second article in a transverse orientation relative to a longitudinal axis of the second clamping member wherein the first channel and the second channel are arranged to enable selective reception of the second article in either orientations; and
a securing element mounted on the lug for retaining the second article within the second accommodating space.

2. The clamp as claimed in claim 1, wherein the first clamping member and the second clamping member are connected together by at least two fasteners wherein the fasteners apply compressive force to secure the first article within the first accommodating space.

3. The clamp as claimed in claim 1, wherein the first accommodating space is shaped to conform to the outer surface of the first article, allowing the first accommodating space to accommodate articles with circular or non-circular cross-sections.

4. The clamp as claimed in claim 1, wherein the lug is integrally formed with the second clamping member, wherein the lug includes a threaded opening section for mounting the securing element, wherein the securing element is a screw which includes a flattened head for uniform clamping of the second article.

5. The clamp as claimed in claim 1, wherein the first channel and the second channel are formed by the lug and a recessed groove on the second clamping member, the first channel and the second channel collectively defining the second accommodating space.

6. The clamp as claimed in claim 1, wherein the lug includes a curved inner surface that defines the first channel, and the second clamping member includes a recessed groove that defines the second channel, the first channel and the second channel partially overlaps to form the second accommodating space having a substantially open profile for receiving the second article.

7. The clamp as claimed in claim 1, wherein the securing element is configured to retain the second article in the second accommodating space when positioned in either the first channel or the second channel, the securing element applies clamping pressure simultaneously across the first channel and the second channel to secure the second article within the second accommodating space.

8. A clamp for securing articles, the clamp comprising:
a first clamping member and a second clamping member, wherein the first clamping member and the second clamping member are connected together by fasteners to form a first accommodating space for securing and retaining a first article;
a lug integrally extending from the second clamping member, the lug and the second clamping member defining a second accommodating space for securing and retaining a second article, wherein the lug extends perpendicularly from the second clamping member and includes a curved inner surface that defines a first channel, and the second clamping member includes a recessed groove that defines a second channel, wherein the first channel and the second channel collectively define the second accommodating space, wherein the second accommodating space is configured to allow, insertion of the second article in a direction transverse to or lateral to a longitudinal axis of the second clamping member without requiring adjustment or reconfiguration of the clamp structure; and
a securing element arranged on the lug for applying a retaining force to the second article within the second accommodating space.

9. The clamp as claimed in claim 8, wherein the fasteners are bolts with flanged heads, and the first clamping member and the second clamping member includes countersunk holes for receiving the fasteners.

10. The clamp as claimed in claim 8, wherein the first channel is adapted to receives the second article in a lateral orientation and the second channel is adapted to receive the second article in a transverse orientation relative to the longitudinal axis of the second clamping member.

11. The clamp as claimed in claim 8, wherein the first channel and the second channel intersect to form a combined opening profile of approximately 270 degrees, allowing insertion of the second article from multiple directions.

12. The clamp as claimed in claim 8, wherein the first channel and the second channel partially overlap to form the second accommodating space having a substantially open profile for receiving the second article.

13. The clamp as claimed in claim 8, wherein the lug is formed with an arcuate profile along the second accommodating space to partially encircle the second article.

14. A clamp for securing articles, the clamp comprising:
a first clamping member and a second clamping member, wherein the first clamping member includes a first engagement surface and the second clamping member includes a second engagement surface, the first engagement surface and the second engagement surface cooperating to define a first accommodating surface for securing a first article;
a lug integrally extending perpendicularly from a top surface of the second clamping member, wherein the lug includes a curved inner surface defining a first channel, and the second clamping member includes a recessed groove defining a second channel, the first channel and the second channel partially overlaps to form a second accommodating space having a substantially open profile for receiving a second article;
wherein the second accommodating space enables side insertion of the second article in either a transverse or lateral direction relative to a longitudinal axis of the second clamping member, without requiring adjustment or reconfiguration of the clamp structure; and
a securing element on the lug for retaining the second article within the second accommodating space when the second article is positioned in either the first channel or the second channel.

15. The clamp as claimed in claim 14, wherein the lug includes a threaded opening section for mounting the screw, and wherein the screw includes a flattened head for uniform clamping of the second article.

16. The clamp as claimed in claim 14, wherein the lug includes a serrated surface on the inner face.

17. The clamp as claimed in claim 14, wherein the clamp is a grounding clamp, the first article is a grounding electrode, and the second article is a grounding conductor.
